(19) United States
(12) Patent Application Publication
(10) Pub. No.: US 2007/0053150 A1
(43) Pub. Date: Mar. 8, 2007

(54) Casing assembly having tongue-and -groove mechanism for coupling upper and lower casing halves

(75) Inventors: In-Shuen Lee, Hinchu City (TW); Chih-Chung Hsieh, Hinchu City (TW); Chun-Jen Tseng, Hinchu City (TW); Jeng-Wen Huang, Hinchu City (TW); Jung-Fu Chen, Hinchu City (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/342,583

(22) Filed: Jan. 31, 2006

(30) Foreign Application Priority Data
Sep. 2, 2005 (TW) 94130166

(51) Int. Cl. G06F 1/16

(52) U.S. Cl. 361/685

(57) ABSTRACT

A casing assembly includes a lower casing half and an upper casing half disposed above and cooperating with the lower casing half to define an outer casing. Each of the lower and upper casing halves has a rear end and a rear side plate extending from the rear end to overlap at least partially with each other. A tongue-and-groove mechanism includes a groove formed in one of the rear side plates and a tongue mounted on the other one of the rear side plates and extending into so as to engage the groove to prevent the lower and upper casing halves from separating.

### FIELD OF THE INVENTION

The invention relates to a casing assembly, more particularly to a casing assembly having tongue-and-groove mechanism for coupling upper and lower casing halves to form an outer casing.

### BACKGROUND OF THE INVENTION

Referring to FIG. 1, a conventional disk drive of slim type is shown to include upper and lower casing halves 4, 6 coupled together to form an outer casing 2. A slim-type disk drive is preferred due to the limited space for many reasons. If the upper and lower casing halves 4, 6 for forming the outer casing 2 are not properly designed, the former two may disengage easily from each other in case of a sudden shock, eventually leading to ruin of the conventional disk drive.

The outer casing 2 has a front end formed with a tray opening 10 to permit withdrawal and extension of a disk-carrying tray (not shown). Each of the upper and lower casing halves 4, 6 has left and right sides, and left and right side plates 8a, 8b extending respectively from the left and right sides to overlap with one another.

FIG. 2 is a perspective bottom view illustrating how a coupling structure 12 coupled the extension parts 14 of the upper and lower casing halves 4, 6 in such a manner that the upper and the lower casing halves 4, 6 are prevented from relative movement by arranging several movement interferences between the left and right side plates 8a, 8b.

The aforesaid coupling structure 12 provides limited improvement to prevent the upper and lower casing halves 4, 6 form separating. Therefore, the outer casing 2 is still susceptible to disengage when suffering a severe shock. Besides, since the coupling structure 12 is only provided on the side of the outer casing 20, the fastening strength at the tray opening 10 in the outer casing 20 is relatively weak, and may result in removal of the upper and lower casing halves 4, 6 at the rear end. Some fastener screws can be employed at the rear end in order to enhance the engagement between the upper and lower casing halves (4,6), but doing so may result in extra manufacturing cost.

### SUMMARY OF THE INVENTION

The object of the present invention is to provide a casing assembly for use in a slim-type disk drive. The casing assembly includes a tongue-and-groove mechanism of simple structure but is adapted to provide a fast and firm engagement between the upper and lower casing halves in order to eliminate the disadvantage encountered during use of the conventional casing assembly.

According to the present invention, a casing assembly for a disk drive is provided to include: a lower casing half; an upper casing half disposed above and cooperating with the lower casing half to define an outer casing, each of the lower and upper casing halves having a rear end and a rear side plate extending from the rear end to overlap at least partially with each other; and a tongue-and-groove mechanism interposed between the rear side plates, and including a groove formed in one of the rear side plates and a tongue mounted on the other one of the rear side plates and extending into so as to engage the groove to prevent the lower and upper casing halves from separating.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of a conventional casing assembly for a disk drive;

FIG. 2 shows a bottom perspective view of the conventional casing assembly;

FIG. 3A is a perspective view of the first embodiment of a slim-type disk drive of the present invention;

FIG. 3B is an enlarged view of an encircled portion shown in FIG. 3A;

FIG. 4A is a turnover perspective view of an upper casing half employed in the first embodiment to form an outer casing;

FIG. 4B is an enlarged view of an encircled portion shown in FIG. 4A;

FIG. 4C is perspective view of a lower casing half employed in the first embodiment to form the outer casing;

FIG. 4D is an enlarged view of an encircled portion shown in FIG. 4C;

FIG. 5 is an exploded and partly fragmentary view of the first embodiment of the disk drive of the present invention;

FIG. 6A is a fragmentary view of a modified embodiment of FIG. 5;

FIG. 6B is an enlarged view of an encircled portion shown in FIG. 6A;

FIG. 7A is a perspective view of the second embodiment of the slim-type disk drive of the present invention;

FIG. 7B is an enlarged view of an encircled portion shown in FIG. 7A;

FIG. 8A is a turnover perspective view of an upper casing half employed in the second embodiment of the present invention to form an outer casing;

FIG. 8B is an enlarged view of an encircled portion shown in FIG. 8A;

FIG. 8C is perspective view of a lower casing half employed in the second embodiment of the present invention to form the outer casing;

FIG. 8D is an enlarged view of an encircled portion shown in FIG. 8C;

FIG. 9A is a perspective view of the third embodiment of the slim-type disk drive of the present invention;

FIG. 9B is an enlarged view of an encircled portion shown in FIG. 9A;

FIG. 10A is a turnover perspective view of an upper casing half employed in the third embodiment of the present invention to form an outer casing;

FIG. 10B is an enlarged view of an encircled portion shown in FIG. 10A;

FIG. 10C is perspective view of a lower casing half employed in the third embodiment of the present invention to form the outer casing; and

FIG. 10D is an enlarged view of an encircled portion shown in FIG. 10C.

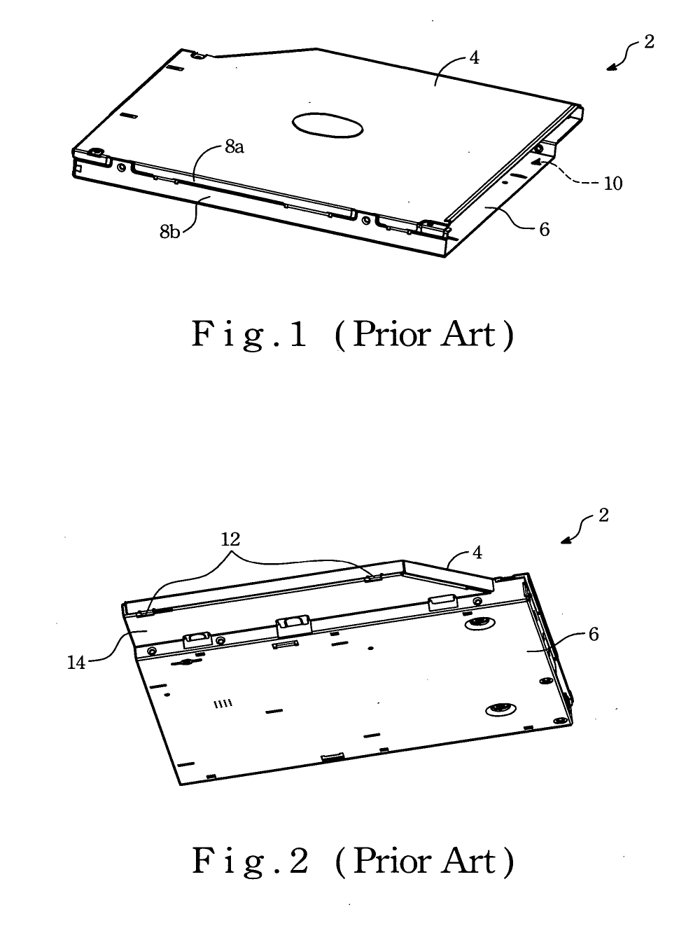

### DETAILED DESCCRIPTIONS OF THE PREFERRED EMBODIMENTS

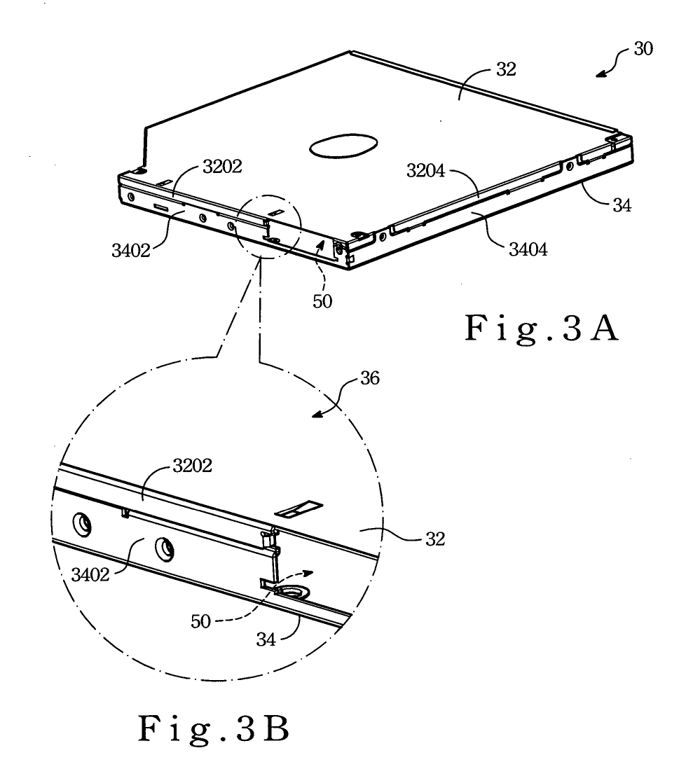

Referring to FIG. 3A, the casing assembly of a slim-type disk drive according to the present invention is shown to include a lower casing half 34, an upper casing half 32 disposed above and cooperating with the lower casing half 34 to define an outer casing 30, and a tongue-and-groove mechanism 36 (shown in FIG. 3B).

As illustrated, each of the lower and upper casing halves 34, 32 has opposite front and rear ends, opposite left and right ends, and a rear side plate 3202, 3402 extending from the rear end to overlap with each other at least partially.

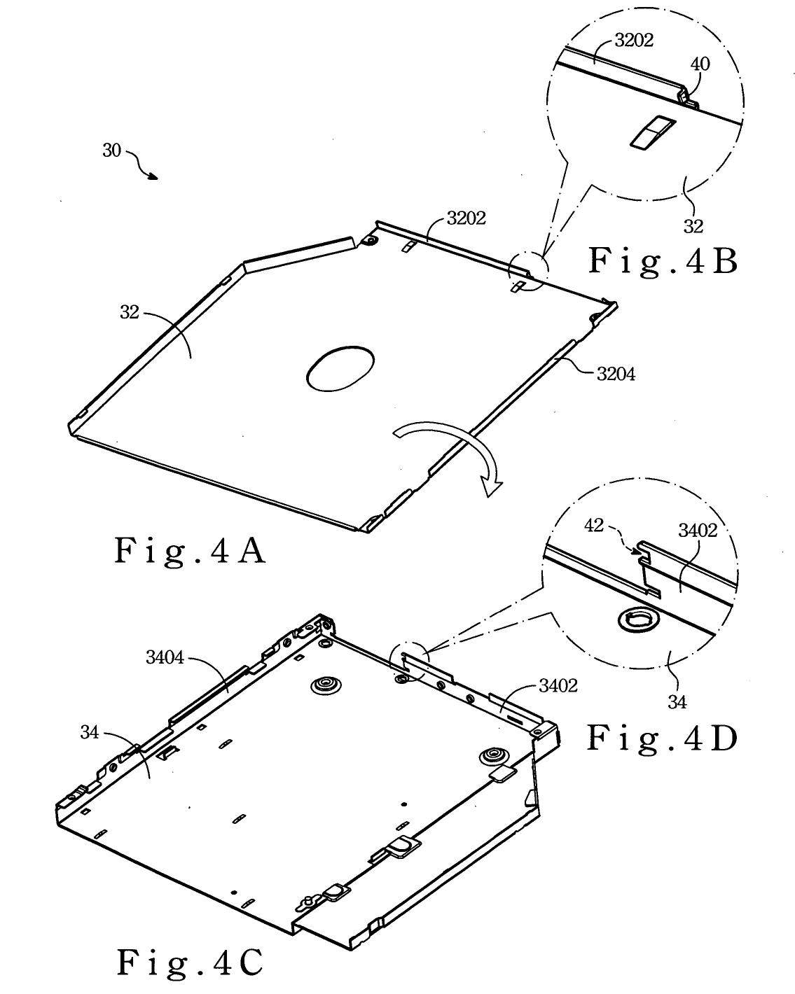

The tongue-and-groove mechanism 36 is interposed between the rear side plates 3202, 3402, and includes a first groove 42 formed in the rear side plate 3402 of the lower casing half 34 (see FIGS. 4C and 4D) and a first tongue 40 mounted on the rear side plate 3202 of the upper casing half 32 (see FIGS. 4A and 4B) and extending into so as to engage the first groove 42 to prevent the lower and upper casing halves 34, 32 from separating form each other.

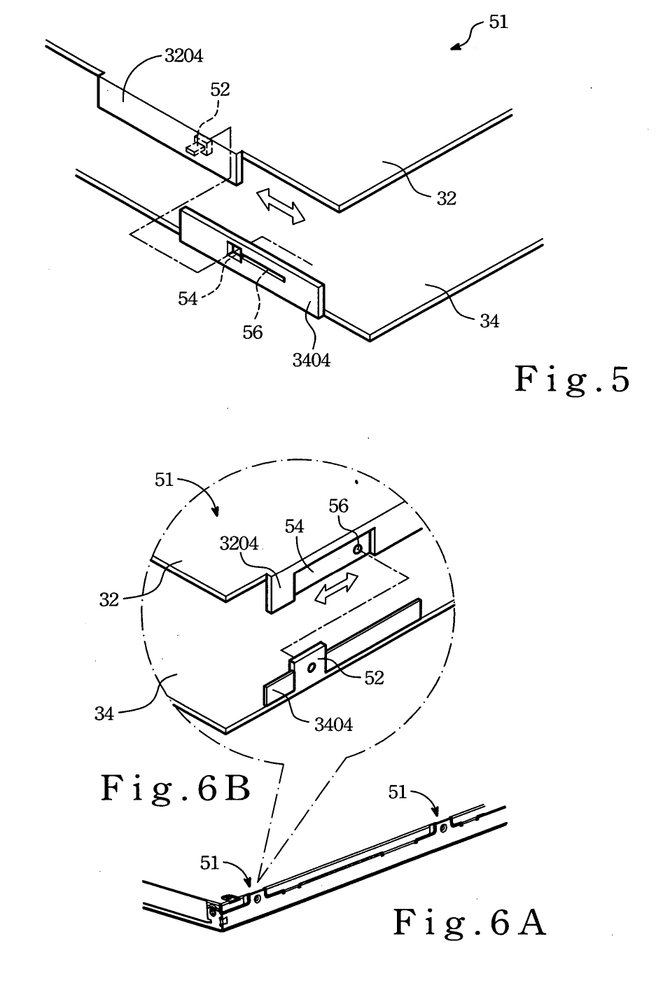

Referring to FIG. 3 again, each of the lower and upper casing halves 34, 32 further has a right side plate 3404, 3204 extending from the right end to overlap with each other. Referring to FIG. 5, in the first embodiment, the tongue-and-groove mechanism 51 further includes a second groove that is mounted on the right side plate 3404 of the lower casing half 34 and that has an enlarged groove portion 54 and a constricted groove portion 56 in spatial communication with the enlarged groove portion 54, and a second tongue 52 that is mounted on and that extends inwardly from an inner side wall of the right side plate 3204 of the upper casing half 32. During assembly of the first embodiment, the upper casing half 32 is disposed above the lower casing half 34, the second tongue 52 is inserted through the enlarged groove portion 54 of the second groove by moving the upper casing half 32 in the left and right direction with respect to the lower casing half 34 and to engage within the constricted groove portion 56 of the second groove upon relative movement between the lower and upper casing halves 34, 32 in the front-and-rear direction of the casing 30, which in turn results in engagement of the first tongue 40 of the upper casing half 32 with the first groove 42 in the lower casing half 34 disposed at the rear side of the casing 30.

Note that a distal enlarged section of the second tongue 52 has a cross section that is smaller than the enlarged groove portion 54 so as to permit extension therethrough and a proximate constricted section that is generally similar the constricted groove portion 56 so as to engage within the constricted groove portion 56 of the second groove.

FIGS. 6A and 6B show a modified embodiment of FIG. 5. The only different resides in that the second groove has a first width. The second tongue 52 has a second width smaller than the first width, wherein a difference between the second and first widths defines a traveling distance of the upper casing half 32 with respect to the lower casing half 34 in the front-and-rear direction during assembly the outer casing 30 in order to engage the first tongue 40 of the upper casing half 32 with the first groove 42 in the lower casing half 34.

In the first embodiment of the present invention, the rear side plate 3202 of the upper casing half 32 is disposed outwardly relative to the rear side plate 3402 of the casing half 34 (see FIG. 3A) while the first groove 42 is formed in the rear side plate 3402 of the lower casing half 34. The first groove 42 is a through hole formed through the rear side plate 3402 of the lower casing half 34 (see FIG. 4D). Preferably, a portion of the rear side plate 3202 of the upper casing half 32 is punched and is bent latter inwardly with respect to the remaining portion of the rear side plate 3202 in order to form the first tongue 40 (see FIG. 4B).

Referring again to FIGS. 3B, 4C and 4D, the rear side plate 3402 of the lower casing half 34 is formed with a connecting port 50 via with the outer casing 30 is coupled to the display screen (such as a TV set) by means of a coupling wire (not shown). The connecting port 50 is in spatial communication with the first groove 42 in the rear side plate 3402 of the lower casing half 34.

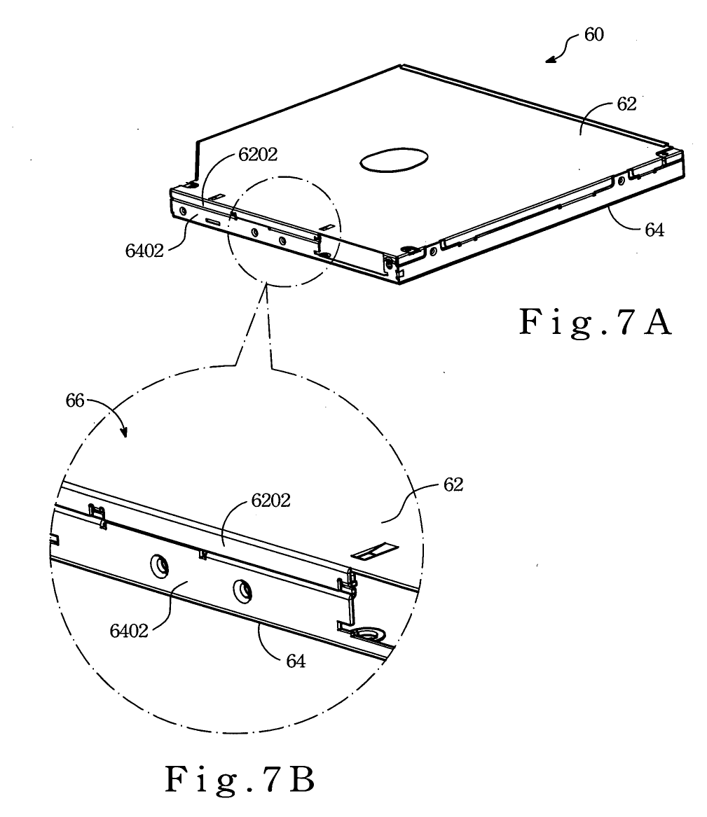

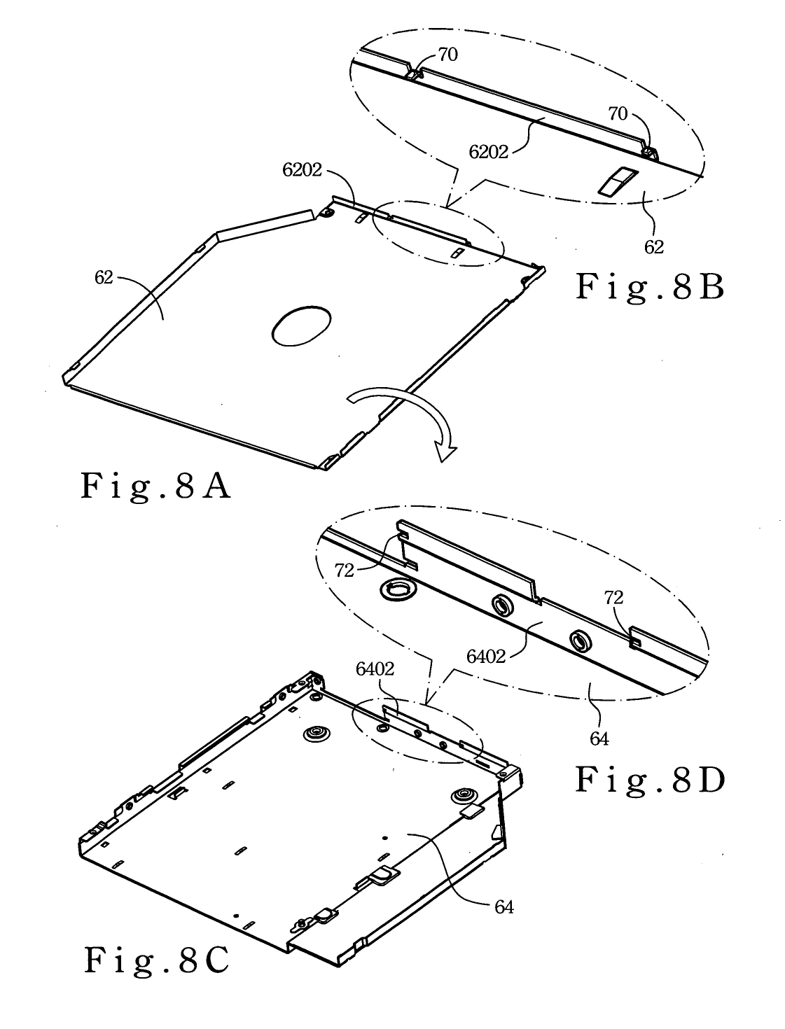

Referring to FIGS. 7A and 7B, the second embodiment of the disk drive of the present invention is shown, wherein the outer casing 60 has the structure similar to the previous embodiment. The main difference resides in that the rear side plate 6202 of the upper casing half 62 has a pair of inwardly bent first tongues 70 (see FIGS. 8A and 8B) while the rear side plate 6402 of the lower casing half 64 is formed with a pair of first grooves 72 (see FIGS. 8C and 8D) in order to complement with the first tongues 70 respectively. The first tongues 70 and grooves 72 cooperatively define the tongue-and-groove mechanism 66 of the second embodiment (see FIG. 7B).

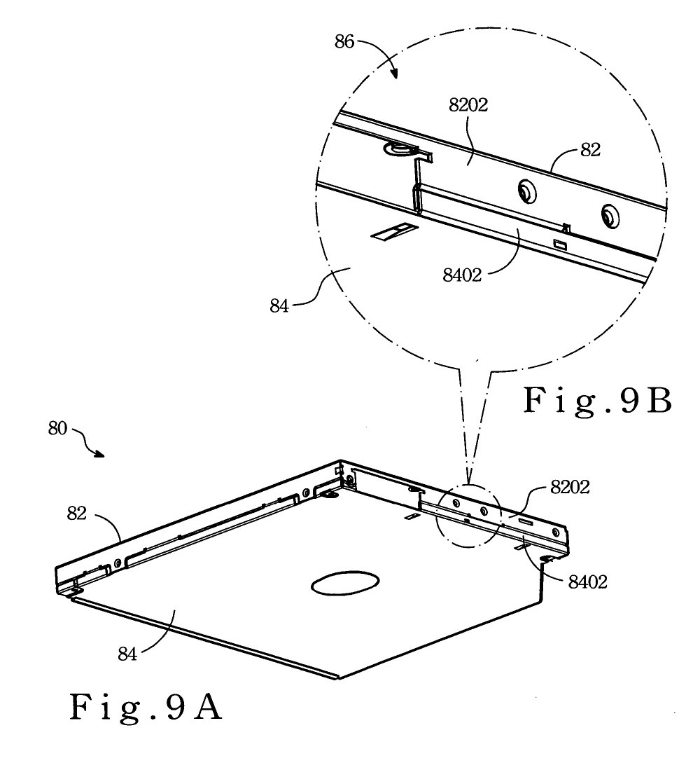

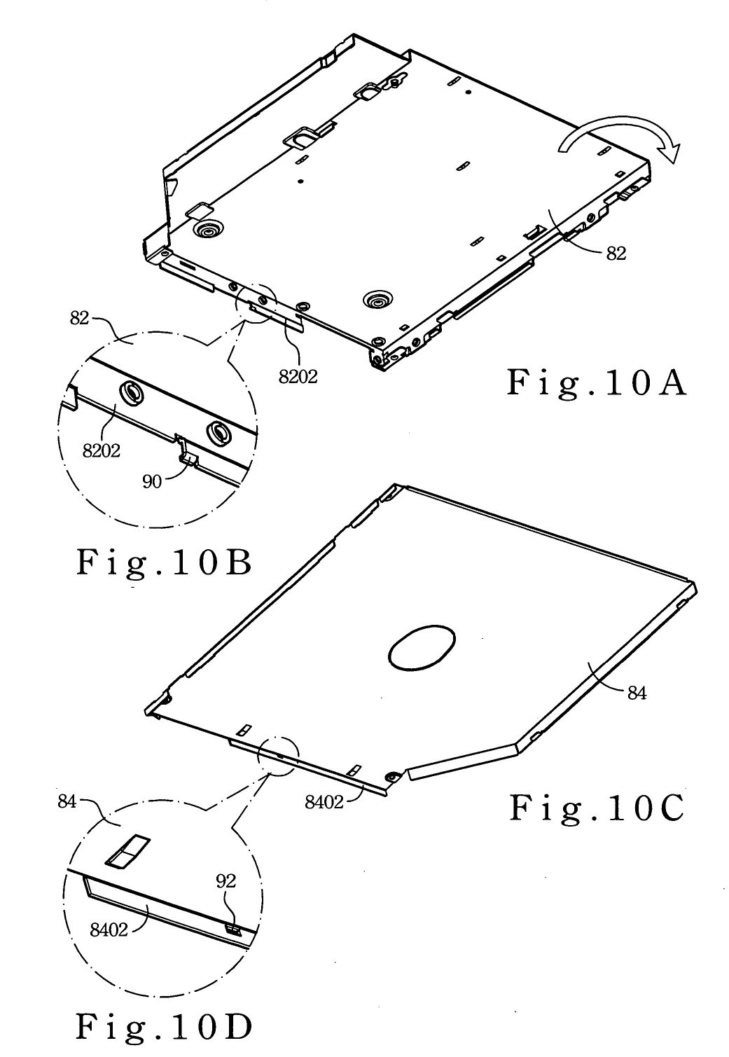

Referring to FIGS. 9A and 9B, the third embodiment of the disk drive of the present invention is shown, wherein the outer casing 80 has the structure similar to the first embodiment. The only difference resides in that the rear side plate 8202 of the upper casing half 82 is disposed inwardly at least partially relative to the rear side plate 8402 of the lower casing half 84. The first groove 92 is formed in the rear side plate 8402 of the lower casing half 84 (see FIGS. 10C and 10D). Under this condition, the first tongue 90 is bent outwardly from the rear side plate 8202 of the upper casing half 82 (see FIGS. 10A and 10B) to engage the first groove 92 in the rear side plate 8402 of the lower casing half 84. The first tongue 90 and groove 92 cooperatively defines the tongue-and-groove mechanism 86 of the third embodiment (see FIG. 9B).

To summarize the above paragraphs, it is observable that the tongue-and-groove mechanism 36, 51, 66, 86 employed the casing assembly of the present invention is simple in structure by provides firm engagement between the upper and lower casing halves to form the outer casing. The tongue and grooves can be formed by easy methods without causing extra expense. Besides, the tongue-and-groove mechanism disposed at the rear side of the outer case enhances the engagement between the upper and lower casing halves. Therefore, the problem encountered in the conventional casing assembly is eliminated.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A casing assembly comprising:
a lower casing half;
an upper casing half disposed above and cooperating with said lower casing half to define an outer casing, each of said lower and upper casing halves having a rear end, and a rear side plate extending from said rear end to overlap with each other; and
a tongue-and-groove mechanism interposed between said rear side plates, and including a first groove formed in one of said rear side plates and a first tongue mounted on the other one of said rear side plates and extending into so as to engage said first groove to prevent said lower and upper casing halves from separating.

2. The casing assembly according to claim 1, wherein each of said lower and upper casing halves further has a right end and a right side plate extending from said right end to overlap with each other, said tongue-and-groove mechanism further including a second groove that is mounted on one of said right side plates and that has an enlarged groove portion and a constricted groove portion in spatial communication with said enlarged groove portion and a second tongue mounted on the other one of said right side plates, wherein during assembly said second tongue is inserted through said enlarged groove portion of said second groove to engage within said constricted groove portion of said second groove upon relative movement between said lower and upper casing halves in a front-and-rear direction of said casing, which in turn results in engagement said first tongue with said first groove.

3. The casing assembly according to claim 2, wherein said second tongue has a distal enlarged section having a cross section greater than that of said constricted groove portion of said second groove and a proximate constricted section engaging within said constricted groove portion of said second groove.

4. The casing assembly according to claim 2, wherein said second groove has a first width, said second tongue 52 having a second width smaller than said first width, wherein a difference between said second and first widths defines a traveling distance of one of said lower and upper casing halves with respect to the other one of said lower and upper casing halves in said front-and-rear direction during assembly said outer casing in order to engage said first tongue with said first groove.

5. The casing assembly according to claim 1, wherein said rear side plate of said upper casing half is disposed outwardly relative to said rear side plate of said lower casing half, said first groove being formed in said rear side plate of said lower casing half, said first tongue being bent inwardly from said rear side plate of said upper casing half to engage said first groove in said rear side plate of said lower casing half.

6. The casing assembly according to claim 1, wherein said rear side plate of said upper casing half is disposed inwardly relative to said rear side plate of said lower casing half, said first groove being formed in said rear side plate of said lower casing half, said first tongue being bent outwardly from said rear side plate of said upper casing half to engage said first groove in said rear side plate of said lower casing half.

7. The casing assembly according to claim 1, wherein said outer casing is used in a slim-type disk drive.

8. The casing assembly according to claim 1, wherein said rear side plate of said lower casing half is formed with a connecting port in spatial communication with said first groove.

9. The casing assembly according to claim 1, wherein said first groove is a through hole formed through said rear side plate of said lower casing half.

10. The casing assembly according to claim 1, wherein a portion of said rear side plate of said upper casing half is punched and bent with respect to the remaining portion of said rear side plate in order to form said first tongue.
